(19) United States
(12) Patent Application Publication
(10) Pub. No.: US 2025/0212089 A1
(43) Pub. Date: Jun. 26, 2025

(54) METHODS AND APPARATUSES RELATING TO WIRELESS COMMUNICATIONS

(71) Applicant: Nokia Technologies Oy, Espoo (FI)

(72) Inventors: Oana-Elena BARBU, Aalborg (DK); Ryan KEATING, Chicago, IL (US); Benny VEJLGAARD, Gistrup (DK)

(73) Assignee: Nokia Technologies Oy, Espoo (FI)

(21) Appl. No.: 18/849,708

(22) PCT Filed: Mar. 30, 2022
(86) PCT No.: PCT/EP2022/058501

§ 371 Date: Sep. 23, 2024

(51) Int. Cl. H04W 40/12; H04B 7/06; H04B 17/309

(52) U.S. Cl. CPC H04W 40/12; H04B 7/06952; H04B 17/309

(57) ABSTRACT

This specification describes an apparatus comprising: means for estimating, for a plurality of beams associated with a plurality of signal propagation paths along which signals are determined to have been propagated over a communication channel between a user equipment. UE, and a transmit-receive point, respective contributions to a channel energy of the communication channel: means for identifying, from the plurality of signal propagation paths associated with the plurality of beams and based on the estimated contributions to the channel energy for the plurality of beams, a group of signal propagation paths associated with a shortest path between the UE and the transmit-receive point; and means for determining, using the identified group of paths, signal characteristics for the shortest path for use in determining a position of the UE.

### FIELD

This specification relates generally to wireless communications.

### BACKGROUND

User equipment (UE) devices can communicate wirelessly with transmit-receive points (TRPs), also referred to as ‘transmission-reception points’. Such communication may facilitate a variety of tasks.

### SUMMARY

In a first aspect, this specification describes an apparatus comprising: means for estimating, for a plurality of beams associated with a plurality of signal propagation paths along which signals are determined to have been propagated over a communication channel between a user equipment, UE, and a transmit-receive point, respective contributions to a channel energy of the communication channel; means for identifying, from the plurality of signal propagation paths associated with the plurality of beams and based on the estimated contributions to the channel energy for the plurality of beams, a group of signal propagation paths associated with a shortest path between the UE and the transmit-receive point; and means for determining, using the identified group of paths, signal characteristics for the shortest path for use in determining a position of the UE.

In some examples, the apparatus may further comprise means for determining a likelihood that the shortest path between the UE and the transmit-receive point is a line of sight path. In some examples, the beams may be beams of the transmit-receive point. In some examples, the beams may be beams of the UE.

In some examples, measurements of signals propagated via at the plurality of beams may be used to determine a subset of the plurality of beams, and the group of paths may be identified from paths of the plurality of signal propagation paths that are associated with the subset of the plurality of beams and based on the estimated contributions to the channel energy for the beams of the subset. In some such examples, the subset may be determined based on a desired number of beams for combining, and a value for the desired number of beams for combining may be defined by information received from a location management function or based on a width associated with the plurality of beams. In addition or alternatively, in some examples, the subset may be determined by removing beams from the plurality of beams having a respective determined measurement below a threshold.

In some examples, the plurality of signal propagation paths associated with the plurality of beams may be identified by parsing signals propagated via at the plurality of beams. In some examples, the respective contribution to the channel energy for a given beam may be determined by: determining a first energy that is associated with a first combined channel formed by combining paths from the plurality of signal propagation paths that are associated with multiple beams of the subset, the given beam being included in the multiple beams; and determining a second energy that is associated with a second combined channel formed by combining paths from the plurality of signal propagation paths that are associated with multiple beams of the subset, but excluding the paths associated with the given beam, wherein the respective contribution to the channel energy for a given beam may be determined based on a difference between the determined first energy and the determined second energy. In some such examples, the first energy may be determined by averaging, across one or more subcarriers of the first combined channel, a first channel frequency response associated with the first combined channel. In addition or alternatively, in some examples, the second energy may be determined by averaging, across one or more subcarriers of the second combined channel, a second channel frequency response associated with the second combined channel.

In some examples, the group of paths may be identified from a combined channel comprising paths of the plurality of signal propagation paths that are associated with beams having at least a threshold estimated respective contribution to the channel energy. In some such examples, the group of paths may be identified as an earliest group of paths from the combined channel having a group energy larger than a noise 30 threshold. In addition or alternatively, the group of paths may be identified from the combined channel using a sliding window. In some examples, the signal characteristics for the shortest path may be determined based on signal characteristics of the paths of the group of paths. In some such examples, the signal characteristics for the shortest path may include a shortest path delay, and wherein the shortest path delay is determined based on respective path delays of paths from the group of paths. In addition or alternatively, in some examples, the signal characteristics for the shortest path may include a shortest path gain, and the shortest path gain may be determined based on respective path gains of paths from the group of paths.

In a second aspect, this specification describes an apparatus comprising at least one processor and at least one memory including computer program code, the at least one memory and the computer program code being configured to, with the at least one processor, cause the apparatus at least to perform: estimating, for a plurality of beams associated with a plurality of signal propagation paths along which signals are determined to have been propagated over a communication channel between a user equipment, UE, and a transmit-receive point, respective contributions to a channel energy of the communication channel; identifying, from the plurality of signal propagation paths associated with the plurality of beams and based on the estimated contributions to the channel energy for the plurality of beams, a group of signal propagation paths associated with a shortest path between the UE and the transmit-receive point; and determining, using the identified group of paths, signal characteristics for the shortest path for use in determining a position of the UE.

In some examples, the at least one memory and the computer program code may be further configured to, with the at least one processor, cause the apparatus at least to perform: determining a likelihood that the shortest path between the UE and the transmit-receive point is a line of sight path. In some examples, the beams may be beams of the transmit-receive point. In some examples, the beams may be beams of the UE.

In some examples, measurements of signals propagated via at the plurality of beams may be used to determine a subset of the plurality of beams, and the group of paths may be identified from paths of the plurality of signal propagation paths that are associated with the subset of the plurality of beams and based on the estimated contributions to the channel energy for the beams of the subset. In some such examples, the subset may be determined based on a desired number of beams for combining, and a value for the desired number of beams for combining may be defined by information received from a location management function or based on a width associated with the plurality of beams. In addition or alternatively, in some examples, the subset may be determined by removing beams from the plurality of beams having a respective determined measurement below a threshold.

In some examples, the plurality of signal propagation paths associated with the plurality of beams may be identified by parsing signals propagated via at the plurality of beams. In some examples, the respective contribution to the channel energy for a given beam may be determined by: determining a first energy that is associated with a first combined channel formed by combining paths from the plurality of signal propagation paths that are associated with multiple beams of the subset, the given beam being included in the multiple beams; and determining a second energy that is associated with a second combined channel formed by combining paths from the plurality of signal propagation paths that are associated with multiple beams of the subset, but excluding the paths associated with the given beam, wherein the respective contribution to the channel energy for a given beam may be determined based on a difference between the determined first energy and the determined second energy. In some such examples, the first energy may be determined by averaging, across one or more subcarriers of the first combined channel, a first channel frequency response associated with the first combined channel. In addition or alternatively, in some examples, the second energy may be determined by averaging, across one or more subcarriers of the second combined channel, a second channel frequency response associated with the second combined channel.

In some examples, the group of paths may be identified from a combined channel comprising paths of the plurality of signal propagation paths that are associated with beams having at least a threshold estimated respective contribution to the channel energy. In some such examples, the group of paths may be identified as an earliest group of paths from the combined channel having a group energy larger than a noise threshold. In addition or alternatively, the group of paths may be identified from the combined channel using a sliding window. In some examples, the signal characteristics for the shortest path may be determined based on signal characteristics of the paths of the group of paths. In some such examples, the signal characteristics for the shortest path may include a shortest path delay, and wherein the shortest path delay is determined based on respective path delays of paths from the group of paths. In addition or alternatively, in some examples, the signal characteristics for the shortest path may include a shortest path gain, and the shortest path gain may be determined based on respective path gains of paths from the group of paths.

In a third aspect, this specification describes a user equipment device or a transmit-receive point for a communications network comprising an apparatus as described above with reference to the first or second aspects.

In a fourth aspect, this specification describes a method comprising: estimating, for a plurality of beams associated with a plurality of signal propagation paths along which signals are determined to have been propagated over a communication channel between a user equipment, UE, and a transmit-receive point, respective contributions to a channel energy of the communication channel; identifying, from the plurality of signal propagation paths associated with the plurality of beams and based on the estimated contributions to the channel energy for the plurality of beams, a group of signal propagation paths associated with a shortest path between the UE and the transmit-receive point; and determining, using the identified group of paths, signal characteristics for the shortest path for use in determining a position of the UE.

In some examples, the method further comprises determining a likelihood that the shortest path between the UE and the transmit-receive point is a line of sight path. In some examples, the beams may be beams of the transmit-receive point. In some examples, the beams may be beams of the UE.

In some examples, measurements of signals propagated via at the plurality of beams may be used to determine a subset of the plurality of beams, and the group of paths may be identified from paths of the plurality of signal propagation paths that are associated with the subset of the plurality of beams and based on the estimated contributions to the channel energy for the beams of the subset. In some such examples, the subset may be determined based on a desired number of beams for combining, and a value for the desired number of beams for combining may be defined by information received from a location management function or based on a width associated with the plurality of beams. In addition or alternatively, in some examples, the subset may be determined by removing beams from the plurality of beams having a respective determined measurement below a threshold.

In some examples, the plurality of signal propagation paths associated with the plurality of beams may be identified by parsing signals propagated via at the plurality of beams. In some examples, the respective contribution to the channel energy for a given beam may be determined by: determining a first energy that is associated with a first combined channel formed by combining paths from the plurality of signal propagation paths that are associated with multiple beams of the subset, the given beam being included in the multiple beams; and determining a second energy that is associated with a second combined channel formed by combining paths from the plurality of signal propagation paths that are associated with multiple beams of the subset, but excluding the paths associated with the given beam, wherein the respective contribution to the channel energy for a given beam may be determined based on a difference between the determined first energy and the determined second energy. In some such examples, the first energy may be determined by averaging, across one or more subcarriers of the first combined channel, a first channel frequency response associated with the first combined channel. In addition or alternatively, in some examples, the second energy may be determined by averaging, across one or more subcarriers of the second combined channel, a second channel frequency response associated with the second combined channel.

In some examples, the group of paths may be identified from a combined channel comprising paths of the plurality of signal propagation paths that are associated with beams having at least a threshold estimated respective contribution to the channel energy. In some such examples, the group of paths may be identified as an earliest group of paths from the combined channel having a group energy larger than a noise threshold. In addition or alternatively, the group of paths may be identified from the combined channel using a sliding window. In some examples, the signal characteristics for the shortest path may be determined based on signal characteristics of the paths of the group of paths. In some such examples, the signal characteristics for the shortest path may include a shortest path delay, and wherein the shortest path delay is determined based on respective path delays of paths from the group of paths. In addition or alternatively, in some examples, the signal characteristics for the shortest path may include a shortest path gain, and the shortest path gain may be determined based on respective path gains of paths from the group of paths.

In a fifth aspect, this specification describes a non-transitory computer readable medium comprising program instructions stored thereon for performing at least any of the operations described above with reference to the first to fourth aspects.

### BRIEF DESCRIPTION OF THE FIGURES

For better understanding of the present application, reference will now be made by way of example to the accompanying drawings in which:

FIG. 1A is an example illustrating communications between a UE and a transmit-receive point;

FIG. 1B is a graph illustrating error in a determined position of a UE which may occur as a result of beam offset;

FIG. 2 is an example message flow sequence;

FIG. 3 is another example illustrating communications between a UE and a transmit-receive point;

FIG. 4 is an example message flow sequence;

FIGS. 5 and 6 are flowcharts illustrating various operations which may be performed in accordance with examples described herein;

FIG. 7 is a schematic illustration of an example configuration of a computing apparatus which may be configured to perform various operations described with reference to FIGS. 1 to 6;

FIG. 8 is a schematic illustration of an example configuration of a transmit-receive point which may be configured to perform various operations described with reference to FIGS. 1 to 6;

FIG. 9 is an illustration of a computer-readable medium upon which computer readable code may be stored.

### DETAILED DESCRIPTION

In the description and drawings below, like reference numerals refer to like elements throughout.

There exists a potential for beam imperfections when UE devices communicate with TRPs. In particular, spurious phase shifts and/or delays may be produced by the radio frequency chain, thereby causing beams (e.g. but not limited to receive beams of the UE or receive beams of the TRP) to be offset from their intended orientation and/or to ‘leak’ energy into adjacent beams via beam side-lobes (an effect sometimes referred to as ‘spatial aliasing’). This can lead to reduced accuracy when signals transmitted between the UE and TRP are used to determine a position of the UE.

Implementations of the technology described herein relate to determination of signal characteristics of a shortest path between a UE and a TRP. Such implementations may enable accurate determination of such signal characteristics. This may be achieved, at least in part, by estimating respective contributions of beams to a channel energy of a communication channel between the UE and the TRP and identifying a group of paths associated with the shortest path based on such estimated contributions. Determination of shortest path signal characteristics based on such a group of paths may allow for information from multiple beams to be combined, thereby to capture a greater amount of shortest path energy than might be captured if information from a single beam (e.g. the beam with the highest line of sight, LOS, probability) were used alone. For instance, information that might otherwise have leaked among adjacent beams and/or their side-lobes may be captured. The determined signal characteristics for the shortest path may be used to provide beneficial technical effects such as, but not limited to, reducing inaccuracies caused by beam imperfections (i.e. beam offset and side-lobes) when signals transmitted between the UE and TRP are used to determine a position of the UE. Put in other terms, various implementations of the technology described herein may provide a hierarchical procedure of multipath (i.e. shortest path and paths other than the shortest path) detection that relies on smartly combining information from several receive beams, in order to minimize the effect of the RX beam imperfections (i.e., beam offset and sidelobes) on the positioning accuracy.

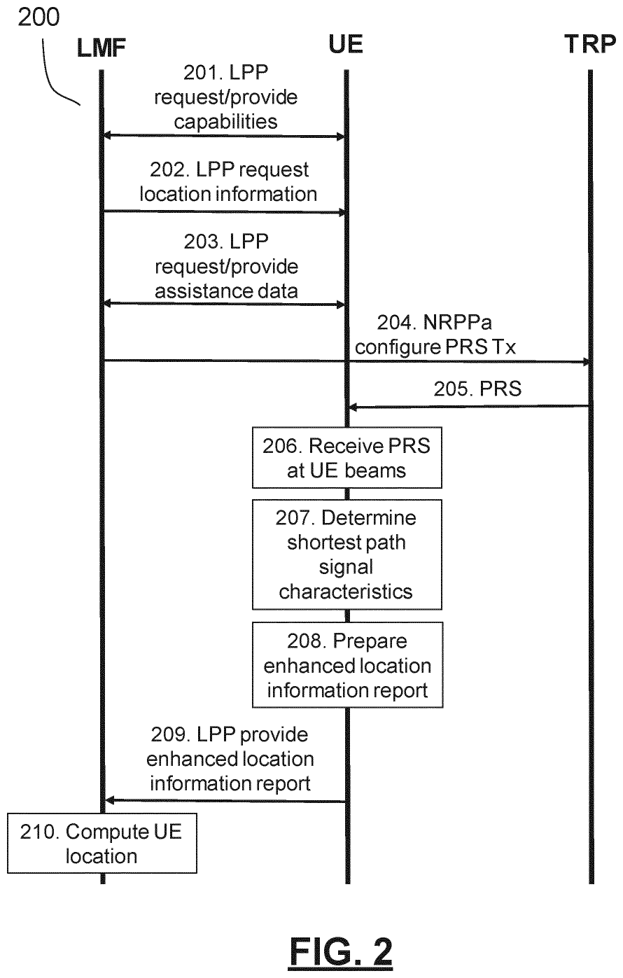

Although by no means limited to such an implementation, the examples of the technology described herein may be readily integrated into any new radio (NR) UE or TRP which performs LPP positioning as defined in TS 37.355, for instance in the manner depicted in FIG. 2 herein. Furthermore, examples of the technology described herein may be compliant with Release 17 of TS 37.355 and may also be applicable to future sidelink (SL) positioning which is expected to be specified in Release 18, particularly if SL positioning incorporates one or more of the positioning methods of Release 17 that utilise the radio interface between the UE and the RAN.

Various methods and apparatuses are described in detail below, by way of example only, in the context of signals propagated via receive (‘Rx’) beams of a UE or TRP. However, it will be appreciated that the techniques described herein may also be applicable to signals propagated via transmit (‘Tx’) beams of a UE or TRP.

For cases in which signals are propagated via (e.g. received by) Rx beams of a UE or TRP, received signals may be associated with the Rx beam at which they were received.

This may allow for information from multiple Rx beams to be combined in accordance with the techniques described herein.

For cases in which signals are propagated via (e.g. transmitted by) Tx beams of a UE or TRP, each propagated signal may include information indicative of the specific Tx beam via which the signal has been transmitted (e.g. but not limited to, a beam index). In this way, the receiver (i.e. the TRP or UE) may be able to identify which of the Tx beams each of the signals was propagated via, thereby allowing for the received signals to be associated with particular Tx beams. This may allow for information from multiple Tx beams to be combined in accordance with the techniques described herein.

It will of course be appreciated that the techniques described herein may also be applicable to any beamed signals transmitted between a UE and a TRP. For instance, in some examples, signals may be propagated via Tx beams of the TRP and Rx beams of the UE (or vice versa), and information across multiple Tx and/or Rx beams may be combined as described herein.

Signal characteristics of a shortest path between a UE and a TRP may be used in determining a position of the UE. Such characteristics may include one or more of path delay, path gain, path phase, angle of arrival and/or angle of departure in uplink (UE to TRP) or downlink (TRP to UE) signals. Such signals may include but are not limited to sounding reference signals (SRS) and positioning reference signals (PRS). Such characteristics may be used in various positioning methods, such as but not limited to those which use time difference of arrival (in either uplink or downlink), time of arrival (when the UE and TRP are synchronised), angle of arrival, angle of departure, and/or multi-round trip time (multi-RTT).

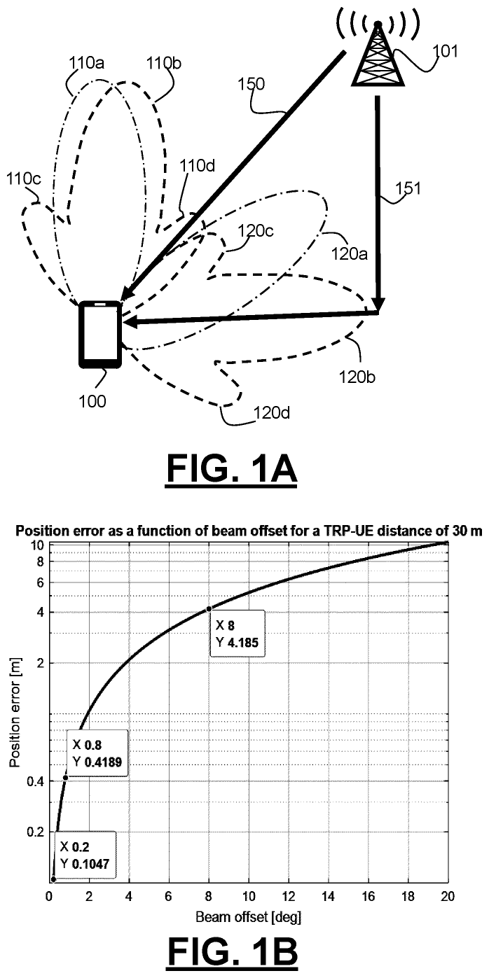

As noted above, in some situations, beam offsets and/or the presence of side lobes (i.e. local maxima in a radiation pattern that are not the main beam) may lead to inaccuracies in the determination of shortest path characteristics. For instance, a signal component transmitted via a shortest path (such as a line of sight, LOS, path) may be captured with much lower energy than another signal component transmitted via a path other than the shortest path (such as a non-line of sight, NLOS, path). In some such examples, this may lead to the receiver wrongly identifying the path other than the shortest path as the shortest path. Such misidentification may, in some examples, cause the delay of the path other than the shortest path to be wrongly recorded as the delay of the shortest path and/or cause the beam associated with the path other than the shortest path to be wrongly recorded as associated with the shortest path. Such erroneous measurements may then, in some examples, be used to calculate a location of the UE (e.g. but not limited to, using a ToA or AoA/AOD calculation). This may lead to inaccuracies in the calculated UE location. Such inaccuracies may, for instance, be in the order of metres, such as illustrated in FIG. 1B, which shows an example of error in the determined position of a UE as a function of beam offset for a TRP-UE distance of thirty metres. Determination of signal characteristics of a shortest path between the UE and the TRP as described herein may therefore lead to a reduction in such inaccuracies when determining a UE location.

In some examples, the term ‘shortest path’ may refer to a signal propagation path of least length between the UE and the TRP. For instance, signals (e.g. but not limited to, radio frequency, RF, signals) transmitted via a shortest path may travel in a substantially straight line between the TRP and the UE. In some such examples, signals transmitted via the shortest path may pass though obstructions and be partially absorbed. As described above, in some examples, the shortest path may be a line of sight path. In some such examples, the term ‘line of sight path’ may refer to a signal path between the UE and the TRP along which the TRP is directly visible from the UE, and vice versa. For instance, signals (e.g. but not limited to, radio frequency, RF, signals) transmitted via a LOS path may travel in a substantially straight line between the TRP and the UE, without obstruction.

In some examples the term ‘path other than the shortest path’ may refer to a signal propagation path of length longer than that of the shortest path.

In some such examples, the path other than the shortest path may be an indirect path between the UE and TRP. For instance, signals (e.g. but not limited to, radio frequency, RF, signals) transmitted via a path other than the shortest path may travel in a non-straight path (e.g. but not limited to a path which includes one or more reflections) between the TRP and the UE, or travel in a substantially straight line between the TRP and the UE through an obstruction. It will be appreciated that signals transmitted via a path other than the shortest path may be reflected, diffracted, refracted or absorbed by the ground, atmosphere, buildings or other obstacles in the environment. As described above, in some examples, paths other than shortest path may be non-line of sight paths. In some such examples, the term ‘non-line of sight path’ may refer to a signal propagation path between the UE and the TRP along which the TRP is not directly visible from the UE, and vice versa.

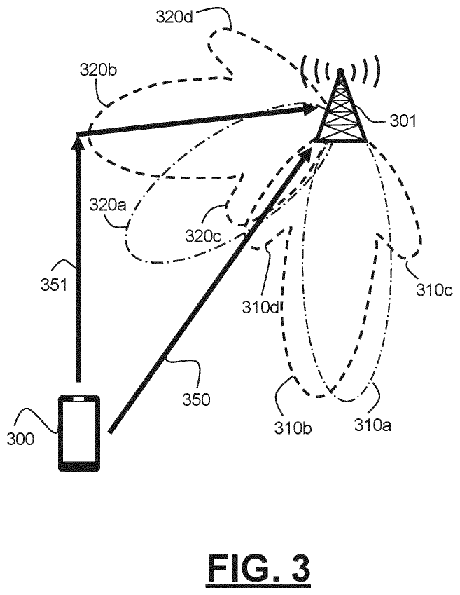

Various methods and apparatuses are described in detail below, by way of example only, in the context of a cellular network, such as an Evolved Universal Terrestrial Radio Access (E-UTRA) network or a 5G network. However, it will be appreciated that the techniques may be applicable with communications networks of other types (e.g. but not limited to other types of cellular network). The cellular network described herein comprises one or more TRPs, which are sometimes referred to as base stations or access points (e.g. but not limited to gNBs and/or eNBs). Whilst a single TRP is depicted in FIGS. 1 and 3, a radio access network (RAN, NG-RAN) may typically comprise thousands of such TRPs. Together, the TRPs may provide cellular network coverage to one or more UEs over a wide geographical area. Furthermore, it is noted that some of the positioning methods for which the described technology may be useful may utilise multiple TRPs to determine the position of a UE. For instance, in some non-limiting examples, three TRPs may be used to triangulate the position of the UE. Accordingly, in some implementations, the approaches described herein may be performed in respect of signals communicated between the UE and each of multiple TRPs. Put another way, shortest signal characteristics may be determined in the manner described herein for each of multiple TRPs communicating with a common UE.

In some implementations and, for instance, depending on the characteristics of the cellular network, the TRPs and UEs within the network may be configured to communicate with one another, for instance, using an OFDM-based access scheme, such as orthogonal frequency division multiple access (OFDMA) and/or single carrier frequency division multiple access (SC-FDMA). For instance, in some non-limiting examples, OFDMA may be used for downlink (DL) communications whereas SC-FDMA may be used for uplink (UL) communications.

FIG. 1 depicts a UE 100 together with TRP 101. By way of example only, UE 100 is illustrated with a plurality of beams indicated by superposed dashed lines. An alternative situation in which the plurality of beams are beams of the TRP is described with reference to FIG. 3. In the example of FIG. 1, the plurality of beams includes a first beam 110 having main lobe 110b depicted as offset from ‘ideal beam’ 110a, first beam 110 having side lobes 110c-d, and second beam 120 having main lobe 120b depicted as offset from ‘ideal beam’ 120a, second beam 120 having side lobes 120c-d. In this example, the term ‘ideal beam’ refers to the beam as designed, that is to say a beam without an offset or side lobes. It will of course be appreciated that, in other examples, the plurality of beams may include a different number of beams, as well as beams of different offsets, orientations, sizes, shapes, and/or with different numbers, shapes or orientations of side lobes.

In some examples, the plurality of beams may be associated with a plurality of signal propagation paths (which may be referred to as ‘transmission paths’ or simply ‘paths’ instead) along which signals are determined to have been propagated over a communication channel between UE 100 and TRP 101. For instance, the plurality of signal propagation paths may include shortest path 150 and path other than the shortest path 151. As described above, in some examples, signals (e.g. but not limited to, radio frequency, RF, signals) transmitted via shortest path 150 may travel in a substantially straight line between TRP 101 and UE 100 without obstruction. On the other hand, in some examples, signals transmitted via path other than the shortest path 150 may follow an indirect (e.g. zig-zag) path, e.g. as a consequence of reflections on the ground, atmosphere, buildings or other obstacles in the environment. Whilst only one path other than the shortest path is depicted in FIG. 1, it will of course be appreciated that the plurality of signal propagation paths between UE 100 and TRP 101 may, in some examples, include multiple different paths other than the shortest path, which can vary in shape and/or length.

In the non-limiting example of FIG. 1, signals transmitted via shortest path 150 may be received at side lobe 110d of the first beam 110 and/or side lobe 120c of the second beam 120, whilst signals transmitted via path other than the shortest path 151 may be received via main lobe 120b of the second beam 120. As such, signals transmitted via path other than the shortest path 151 may be captured with a higher energy than signals transmitted via shortest path 150. This may lead to the UE 100 wrongly identifying path other than the shortest path 151 as the shortest path 150. As described above, this may lead to a path delay associated with the path other than the shortest path 151 being wrongly used as a time of arrival (ToA) and/or the angle of ideal beam 120a being wrongly used as an angle of arrival (AoA) in a positioning calculation for the UE device 100, thereby leading to inaccuracies in the calculated position. Moreover, in some instances, these measurements may be used to identify a LOS probability for the TRP, potentially leading to further inaccuracies when performing various tasks that depend on this information. Implementations of the technology described herein may therefore reduce such inaccuracies, not least by allowing for accurate determination of signal characteristics of the shortest path between the UE 100 and TRP 101.

In some examples, for the plurality of beams associated with the plurality of signal propagation paths, respective contributions to a channel energy may be estimated. In some examples, the term ‘channel energy’ may refer to the total amount of energy transmitted via a communications channel (e.g. but not limited to, a wireless link between UE 100 and TRP 101, or a particular range of frequencies). In broad terms, the respective contributions to the channel energy for each beam may, in some examples, be estimated by combining information associated with paths from various different beams in turn. Details of such ‘combining’ are described below.

In some examples, signals may be transmitted from TRP 101 via the plurality of signal propagation paths and received at the plurality of beams of UE 100. In some such examples, the signals may be downlink positioning reference signals (DL-PRS). In some examples, one or more measurements may be determined for each beam of the plurality of beams based on the received signals. For instance, in some examples, the one or more measurements may comprise a power measurement (e.g. but not limited to, a reference signal received power, RSRP, measurement, a received signal strength indicator, RSSI,), a signal-to-noise ratio (SNR) measurement, a signal-to-noise-plus-interference ratio (SNIR), a beam line of sight probability (for instance, determined using a line of sight/non-line of sight classification algorithm), and/or other measurements. In some examples, respective beam indices may be used to identify measurements corresponding to specific beams of the plurality of beams.

In some examples, as described above, beam line of sight probability may be determined using a line of sight/non-line of sight classification algorithm. For instance, in some such examples, the line of sight/non-line of sight classification algorithm may be implemented by a machine learning module (e.g. but not limited to, a supervised learning module) that has been trained based on training data to receive as input beam measurements (e.g. but not limited to, some or all of the one or measurements described above) and to output, based on the input beam measurements, a beam line of sight probability. In some such examples, the machine learning module may be a neural network. For instance, the neural network may be an artificial neural network comprising a plurality of nodes, the nodes having activation functions (e.g. but not limited to, sigmoid or softmax functions).

In some examples, a subset of the plurality of beams may be identified for ‘combining’, in accordance with various examples describes herein. As will be appreciated from the below discussion, identification of such a subset of beams may be referred to as down-selection of the ‘best’ K beams. For instance, the subset may be identified based on measurements of signals received at the plurality of beams, such as, but not limited to one of measurements determined for each beam above (e.g. RSRP, RSSI, SNR, SNIR and beam line of sight probability). In addition or alternatively, the subset may be identified based on a desired number of beams for combining. For instance, a value for the desired number of beams for combining, K, may be selected by the UE. In some non-limiting examples, the selection may be based on widths of the beams and/or a table mapping beam widths to values for the desired number of beams for combining. For instance, K may be selected to be inversely proportional to the beam width. This may ensure that all relevant beams are considered in the combination process. Alternatively, a value for the desired number of beams may be included in data (e.g. but not limited to, LTE positioning protocol, LPP, assistance data) received from a location management function (LMF).

In some examples, the subset of the plurality of beams may be determined by removing beams from the plurality of beams which have a respective determined measurement (e.g. but not limited to a RSRP measurement) below a threshold. In some examples, this process may be repeated for the same or different measurements (e.g. LOS probability, SNR) and/or different thresholds until the size of the subset is no larger than the desired number of beams for combining. In one such example, the subset of beams may be determined by first ordering the beams according to their LOS probability. Next, the beams with RSRP below a given threshold may be removed. If, after considering RSRP, more than the desired number of beams K remain, SNR may be considered to further reduce the number of beams. For instance, beams having a SNR that is below a threshold may be removed. If, following this, the number of beams remaining still exceeds K, the SNR threshold may be increased, and beams with an SNR below this new threshold may be removed. If the number of beams remaining still exceeds K, the SNR threshold may be increased again, and beams with an SNR below this second new threshold may be removed. The SNR may be increased multiple times until it is determined that the number of beams is equal to (or is less than) K.

The beams of the plurality of beams and/or the subset of the plurality of beams may be ranked according to one or more of the determined measurements (e.g. but not limited to, LOS probability). In some examples, the beams of the plurality of beams may be ranked prior to determining the subset. In some such examples, the subset may be determined based on the ranking, for instance the K highest ranked beams may be selected as the subset. In other examples, the beams of the subset may be ranked once the subset has been identified.

The estimated contributions to the channel energy for each beam in the subset may be estimated by combining information from various different beams in turn. For instance, the contributions to the channel energy for each beam may be estimated by combining information from beams of the subset of the plurality of beams. In some such examples, this combining may be performed sequentially based on a ranking of the beams, such as (but not limited to) the ranking described above.

The signals received at each beam of the subset of the plurality of beams may be parsed to identify one or more taps. For instance, the taps may correspond to different propagation paths taken by signals propagated over a communication channel between the TRP 101 and the UE 100. In some such examples, parsing the signals may allow for the V strongest taps (i.e. taps corresponding to the largest power/path gain) for each beam to be identified, where V is a positive integer corresponding, in some examples, to a maximum number of channel paths. In some such examples, V may be predetermined (e.g. but not limited to, based on standardised channel models such as 3GPP clustered delay line, CDL, and/or tapped delay line, TDL).

The identified taps/paths may then be associated with various signal characteristics. For instance, a given path may be associated with a respective path gain (e.g. a complex gain) and path delay (e.g. a propagation time delay). Put another way, the respective path delays of the V paths associated with the k^{th} beam may be represented by the vector Dₖ=(Dₖ₁, D_{K2}, . . . . D_{kV}). Similarly, the respective path gains of the V paths associated with the k^{th} beam may be represented by the vector Gₖ=(Gₖ₁, Gₖ₂, . . . . Gₖᵥ). The vectors Dₖ and Gₖ may correspond to an estimate of the channel impulse response (CIR) for the k^{th} beam. In some such examples, the CIR for the k^{th} beam may be given by the following formula: CIR_{K} (t)=Σᵢ₌₁^{V} Gₖᵢδ(t−Dₖᵢ), where t is time and δ(·) is an impulse function (e.g. a Dirac delta).

The CIRs for the beams may be used to determine a respective contribution to the channel energy. For instance, the contribution to the channel energy for a particular beam may be determined based on a summation of the instantaneous powers for the V taps of the beam. In some such examples, this summation may be given by the formula Eₓ=Σᵢ₌₁^{v}|Gᵢₖ|². Alternatively, the respective contributions of the beams to the channel energy may be determined by sequentially combining the paths for each of the beams. For instance, the combining process may be performed until most of the channel energy has been captured by the combining process.

In some examples, the combining process may include one or more of the following steps being performed for each of plural beams k=1, 2, . . . , K.

Firstly, paths corresponding to the beams 1 to k may be combined into a single channel. For instance, in some examples, gain and delay vectors for this channel, GG and DD, may be determined by appending GG=(Gₖ, Gₖ₋₁, . . . , G₁) and DD=(Dₖ, Dₖ₋₁, . . . , D₁). In some such examples, these vectors may correspond to a combined channel impulse (CCIR) for the beams 1 to k. For instance, the CCIR for beams 1 to k may be given by the formula CCIR_{K} (t)=Eⱼ₌₁^{k} CIRⱼ(t)=Σⱼ₌₁^{K}Σᵢ₌₁^{V}Gⱼᵢδ(t−Dⱼᵢ).

In some examples, the gains for the k^{th} beam may be weighted by a beam weight wₖ, such that GG=(W_{K}Gₖ, W_{K-1}Gₖ₋₁, . . . , W₁G₁). For instance, the CCIR may be given by CCIR_{K} (t)=Σⱼ₌₁^{K}wⱼCIRⱼ(t). In some such examples, beam weight wₖ, may be a function of one or more of the measurements determined for the k^{th} beam (e.g. but not limited to, W_{K}=f (SNR_{K})=1/SNR_{K}). In addition or alternatively, the gains may be weighted by information included in LPP assistance data (e.g. but not limited to, Tx gains of the TRP beams).

Secondly, a total channel frequency response (CFR) for the channel resulting from combining the paths associated with beams 1 to k may be determined by taking a Fourier transform of the CCIR. For instance, the CFR may be given by the formula CFR_{K} (ω)= [symbol] [CCIR_{K} (t)](ω). An average channel energy, Eₖ, for the channel resulting from combining the paths associated with beams 1 to k may then be obtained by averaging the CFR across one or more subcarriers associated with the combined channel (for instance, but not limited to, all subcarriers of the channel).

Once the average channel energy, Eₖ, has been determined, an estimated respective contribution to a channel energy for the k^{th} beam may be determined. For instance, in some examples, the estimated respective contribution to the channel energy for the k^{th} beam may be given by Eₖ-Eₖ₋₁, where Eₖ₋₁ was obtained by performing the above steps for the (k-1)^{th} beam. In the case where k=1, the estimated respective contribution to the channel energy may instead be given by E₁. Put another way, the respective contribution to the channel energy for a given beam may be determined by determining a first energy that is associated with a first combined channel and determining a second energy that is associated with a second combined channel. The first combined channel may be formed by combining paths from the plurality of signal propagation paths that are associated with multiple beams of the subset, the given beam being included in the multiple beams. The second combined channel may be formed by combining paths from the plurality of signal propagation paths that are associated with multiple beams of the subset, but excluding the paths associated with the given beam. In some such examples, the respective contribution to the channel energy for a given beam may then be determined based on a difference between the determined first energy and the determined second energy. For instance, in some examples, the first energy may be determined by averaging a first channel frequency response associated with the first combined channel across one or more subcarriers of the first combined channel. Similarly, in some examples, the second energy may be determined by averaging a second channel frequency response associated with the second combined channel across one or more subcarriers of the second combined channel.

If the estimated respective contribution to the channel energy for the k^{th} beam is determined to be low or insignificant (e.g. below a threshold), the paths of the k^{th} beam may be discarded (i.e. removed from GG and DD for subsequent iterations), otherwise the k^{th} beam is kept in the combined channel.

In general terms, performance of the above steps for beams 1 to K may result in identification of a combined channel having paths from across beams 1 to K, where paths associated with beams having a low or insignificant contribution to the total channel energy are discarded. For instance, in some examples, such ‘low energy’ paths may be unlikely to correspond to a shortest path as desired.

By way of example only, consider the case in which K=4. As described above, for instance, it may be determined that the first, second, and fourth beams make a significant (e.g. larger than a threshold) contribution to the energy, whilst the third beam may be determined to make an insignificant contribution to the channel energy. In this case, paths associated with the third beam may be discarded, and the resulting combined channel may therefore correspond to the vectors GG=(G₄, G₂, G₁) and DD=(D₄, D₂, D₁).

In some examples, the above described ‘combination’ process may be performed across multiple carriers having respective pluralities of beams. Such implementations, may be particularly useful in ‘carrier aggregation’ (CA) scenarios. In such examples, the operations described above may be repeated for each of the multiple carriers, resulting in a combined channel having paths associated with beams from one or more of the multiple carriers. In some such examples, the desired number of beams for combining from each carrier may depend on the carrier (i.e. K=K (x), for carrier x). For instance, a different K may be used for different carriers. Likewise, in addition or alternatively, the threshold estimated respective contribution to the channel energy used to identify the combined channel may depend on the carrier as well. For instance, a different energy contribution thresholds may be used for different carriers.

Having determined the combined channel having paths from across beams of the subset (1 to K), a group of paths associated with a shortest path between the UE and the TRP may be identified. That is to say, in some examples, the group of paths may be identified from a combined channel comprising paths of the plurality of signal propagation paths that are associated with beams having at least a threshold estimated respective contribution to the channel energy. In some examples, the group of paths may instead be referred to as a ‘cluster’ of paths.

In some examples, the identified group of paths may correspond to an earliest group of paths from the combined channel (i.e. a group of least path delay, such as, but not limited to, an earliest set of time-clustered paths), which have a group energy, E_{G}, larger than a noise threshold. For instance, the group energy may be determined based on a summation of instantaneous powers of the paths of the group, though it will be appreciated that other means of determining the group energy may be used in addition or alternatively. The noise threshold may selected so as to balance the likelihood of missed detection and ‘false alarm’.

In some examples, the group of paths may be determined using a sliding window. In some such examples, paths of the combined channel having path delays lying within the sliding window may be included in the group energy calculation. In this case, as the sliding window is moved in the direction of increasing path delays, the first group having group energy larger than the noise threshold may be identified as the group of paths. In some such examples, the sliding window may be of width d=T_{cp}/V, where T_{cp} is a cyclic prefix duration (in some examples, this may cover the longest channel delay) and V is the maximum number of channel paths. As will of course be appreciated, the paths included in the identified group need not necessarily be associated with the same beam. As such, identification of a path group in the manner described above may, in some examples, yield a subset of paths associated with shortest path information that may have ‘leaked’ across multiple beams.

Signal characteristics for the shortest path may be determined using the identified group of paths. This may be referred to as unifying the group of paths around a shortest path with unique signal characteristics (e.g. delay, phase and amplitude). These signal characteristics may then be used in determining a position of the UE. For instance, the signal characteristics for the shortest path may be determined based on signal characteristics of the paths of the identified group of paths.

In some such examples, the signal characteristics for the shortest path may include a shortest path delay (i.e. a delay of the shortest path) that is determined based on respective path delays of paths from group of paths. For instance, the shortest path delay may be determined as a delay spread (e.g. an RMS delay spread) of the paths of the identified group of paths. Alternatively, the shortest path delay may be determined as an average (e.g. but not limited to arithmetic mean, geometric mean, or median) delay of the paths of the group.

In some examples, the signal characteristics for the shortest path may include a shortest path gain (i.e. a gain of the shortest path) that is determined based on respective path gains of paths from group of paths. For instance, the shortest path gain may be determined by combining path gains (which, as noted above, may be complex gains) of the paths of the identified group of paths. The path gains may, for instance, be combined by summation and/or other methods, such as computing a Fourier transform of the group of paths (i.e. a discrete Fourier Transform of a combined impulse response corresponding to the group of paths), followed by computing an inverse Fourier transform evaluated at an estimated shortest path delay.

As described above, the determined signal characteristics of the shortest path may be used in determining a position of the UE. Such a determined position may then be reported to the network for use in performance of various tasks. In addition or alternatively, the signal characteristics may be used in determining a LOS probability for a given TRP. For instance, the determined signal characteristics may allow for such a LOS probability to be updated or set. In some such examples, this information may be reported by a UE to the network (e.g. but not limited to, a location management function, LMF) along with UE device positioning measurements. For instance, Release 17 of TS 37.355 specifies that Line-of-sight/Non-line-of-sight indicators (‘losNlosIndicators’) are reported by the UE along with positioning measurements. In such implementations, the UE may use the determined signal characteristics of the shortest path to determine the appropriate value of the Line-of-sight/Non-line-of-sight indicators.

As will of course be appreciated, in some such examples, determination of appropriate values for the Line-of-sight/Non-line-of-sight indicators using the determined signal characteristics may be accomplished in various ways. For instance, this may be achieved via hypothesis testing. In some such examples, a likelihood ratio test may be performed based on multipath channel statistics (such as, but not limited to, one or more of kurtosis, mean excess delay spread, root mean square delay spread etc.). In addition or alternatively, values for the Line-of-sight/Non-line-of-sight indicators may be determined based on output from machine learning models (e.g. but not limited to, artificial neural networks) trained to receive as input features such as mean excess delay, root mean square (RMS) delay spread, amplitude kurtosis, total received power, rise time, TOA of the first multipath component, and/or maximum signal amplitude. In some examples, values for the Line-of-sight/Non-line-of-sight indicators may be determined based on an assessment of energy received for each of the polarisations of one or more single orthogonal dual-polarised antennas.

In some examples, a likelihood that the shortest path between the UE and the TRP is a line of sight path may be determined. For instance, in some such examples, the likelihood that the shortest path is a LOS path may be determined based on a determined LOS probability. As described above, in some examples, such a LOS probability may be determined using the signal characteristics of the shortest path.

In some examples, the process described with reference to FIG. 1 may be performed at the UE when a new PRS is detected. In other examples, the process may be performed at the UE when a PRS configuration is changed. The PRS configuration may be considered changed, for instance, when a different number of PRS repetitions is detected and/or when a PRS is received from a different TRP. In other examples, the process may be performed at the UE when a path associated with signals received at the 10) UE is similar to another path associated with signals received at the UE (e.g. but not limited to, within a threshold distance using a beam correlation metric). According to other alternative examples, the process described with reference to FIG. 1 may be performed at the UE responsive to a request from the LMF. For instance, such a request may be sent when a recent UE location measurement is of an unsatisfactory quality. In some examples, prior to a request from the LMF, the UE may explicitly inform the LMF, that it is capable of performing the process. Alternatively, in some examples, prior to a request from the LMF, the UE may implicitly inform the LMF that it is capable of performing the process. For instance, in some such examples, the UE may report to the LMF that it is capable of performing ‘mode 1’ measurements, corresponding to low-complexity/low-accuracy measurements, and/or ‘mode 2’, measurements corresponding to high-complexity/high-accuracy measurements. In some such examples, the capability to perform ‘mode 2’ measurements may correspond to the capability to perform the process described with reference to FIG. 1. In this manner, the UE may inform the LMF that it is capable of performing advanced processing (i.e. high-complexity/high-accuracy measurements) without the need to disclose the particular type of advanced processing.

FIG. 2 is a message flow sequence, indicated generally by the reference numeral 200, in accordance with some examples of the described technology. The message flow sequence 200 shows an example implementation within which aspects of a process such as that described with reference to FIG. 1 above may be performed.

The message flow sequence 200 shows a signalling procedure between a location management function (LMF), a UE and a TRP. In some examples, the LMF may be a core network (CN) entity, but could be elsewhere e.g. at the TRP or UE. The UE and TRP may, for example, be the UE 100 and TRP 101 described with reference to FIG. 1 above.

Whilst various operations are described below as being performed by the LMF, in some examples some or all of these operations may be performed by the UE or TRP instead.

In some examples, LMF and UE may exchange signal(s) 201 relating to positioning protocol capabilities (e.g. LPP capabilities) of the UE device. For instance, in some examples, LMF may send to the UE a signal including data indicative of a request for capabilities (e.g. a ‘RequestCapabilities’ message). Such a message may including one or more requested capability types. In response, the UE may send to the LMF a signal including data indicative its positioning capabilities (e.g. a ‘ProvideCapabilities’ message). Such a message may indicate which, if any, of the requested capability types are supported by the UE. In some examples, the signal including data indicative of the UE's positioning capabilities (e.g. a ‘ProvideCapabilities’ message) may be sent by the UE to the LMF in response to another event without prior reception of the signal including data indicative of a request for capabilities (e.g. the ‘RequestCapabilities’ message). This may be performed for instance, but not limited to, when UE connects to the TRP.

In some examples, LMF may send signal(s) 202 to UE relating to (e.g. LPP) location information. For instance, in some examples, LMF may send to the UE a signal including data indicative of a request for location information (e.g. a ‘RequestLocationInformation’ message). In some examples, the signal including data indicative of a request for location information may indicate a type of the requested location information and/or an associated quality of service (QOS) requirement.

In some examples, LMF and UE may exchange signal(s) 203 relating to positioning protocol (e.g. LPP) assistance data. For instance, in some examples, UE may send to the LMF a signal including data indicative of a request for assistance data (e.g. a ‘RequestAssistanceData’ message). In some such examples, the signal including data indicative of a request for assistance data may include a request for information for use in determining a location of the UE. In some examples, the request for assistance data may include a request for a reconfiguration of a specific downlink positioning reference signal. Alternatively, in some examples, the request for assistance data may include a flag which indicates that the LMF is to configure the positioning session (e.g. but not limited to, one or more reference signals) itself, without requests from the UE for reconfiguration of specific reference signals.

In response, the LMF may send to the UE a signal which provides the requested assistance data (e.g. in the form of a ‘ProvideAssistanceData’ message). In some examples, this signal (e.g. the ‘ProvideAssistanceData’ message) may further include unrequested information deemed useful for determining a location of the UE. In some examples, the signal (e.g. the ‘ProvideAssistanceData’ message) may be sent by the LMF to the UE in response to another event without prior reception of a request from the UE (e.g. the ‘RequestAssistanceData’ message). This may occur for instance, but not limited to, when the UE connects to the TRP.

In some examples, LMF may send signal(s) 204 to TRP relating to a positioning reference signal (PRS) transmitter configuration. For instance, these signals may be sent using New Radio Positioning Protocol A (NRPPa). For instance, in some examples, the signals may include information indicative of how the PRS is to be generated, such as, but not limited to, a Zadoff-Chu sequence length/root, a frequency comb, a repetition rate in the time domain, a periodicity in a number of subframes, a carrier frequency to use, and other suitable information.

In some examples, once the PRS transmitter has been configured, TRP may transmit a PRS 205 to the UE device.

In some examples, at operation 206, the UE may receive the transmitted PRS 205. For instance, the UE may receive the transmitted PRS 205 via a plurality of beams of the UE device.

In some examples, at operation 207, responsive to receiving the PRS 205, the UE may determine shortest path signal characteristics based on the received PRS 205. For instance, this operation may be performed in the manner described herein, particularly with reference to FIG. 1 above.

In some examples, at operation 208, the UE may prepare an enhanced location information report. For instance, in some examples, the enhanced location information report may include data indicative of the location information requested in signal(s) 203. In some examples, the shortest path signal characteristics may be included in and/or used to determine the contents of the enhanced location information report.

In some examples, the UE may send signal(s) 209 relating to location information. For instance, in some examples, UE may send a signal including data indicative of a ‘ProvideLocationInformation’ message to the LMF. In some examples, the ‘ProvideLocationInformation’ may include the enhanced location report determined at operation 209 and/or the shortest path signal characteristics determined at operation 208.

In some examples, at operation 210, the LMF may compute a location of the UE device. For instance, this location may be determined based on the determined shortest path signal characteristics and/or the enhanced location report included in signal(s) 209.

Whilst various operations have been described above, by way of example only, primarily with respect to LPP and NRPPa, it will be appreciated that other positioning protocols may be used in addition or alternatively.

FIG. 3 depicts a UE 300 together with TRP 301. In FIG. 3 the TRP 301 is illustrated with a plurality of beams indicated by superposed dashed lines. In some examples, the plurality of beams includes a first beam 310 having main lobe 310b depicted as offset from ‘ideal beam’ 310a, first beam 310 having side lobes 310c-d, and second beam 320 having main lobe 320b depicted as offset from ‘ideal beam’ 320a, second beam 320 having side lobes 320c-d. In this example, the term ‘ideal beam’ refers to the beam as designed, that is to say a beam without an offset or side lobes. It will of course be appreciated that, in other examples, the plurality of beams may include a different number of beams, as well as beams of different offsets, orientations, sizes, shapes, and/or with different numbers, shapes or orientations of side lobes.

In some examples, the plurality of beams may be associated with a plurality of signal propagation paths between UE 130 and TRP 301. For instance, the plurality of signal propagation paths may include shortest path 350 and path other than the shortest path 351. As described above, in some examples, signals (e.g. but not limited to, radio frequency, RF, signals) transmitted via shortest path 350 may travel in a substantially straight line between UE 300 and TRP 301. On the other hand, in some examples, signals transmitted via path other than the shortest path 350 may follow an indirect (e.g. zig-zag) path as shown (e.g. but not limited to, due to reflections on the ground, atmosphere, buildings or other obstacles in the environment). Whilst only one path other than the shortest path is depicted in FIG. 3, it will of course be appreciated that the plurality of signal propagation paths between UE 300 and TRP 301 may, in some examples, include multiple different paths other than the shortest path, which can vary in shape or length.

In the non-limiting example of FIG. 3, signals transmitted via shortest path 350 may be received at side lobe 310d of the first beam 310 and/or side lobe 320c of the second beam 320, whilst signals transmitted via path other than the shortest path 351 may be received via main lobe 320b of the second beam 320. As such, signals transmitted via path other than the shortest path 351 may be captured with a higher energy than signals transmitted via shortest path 350, leading to the TRP 301 wrongly identifying path other than the shortest path 351 as the shortest path 350. As described above, this may lead to a path delay associated with the path other than the shortest path 351 being wrongly used as a time of arrival (ToA) and/or the angle of ideal beam 320a being wrongly used as an angle of arrival (AoA) in a positioning calculation for the UE device 300, thereby leading to inaccuracies in the calculated position. Moreover, in some examples, these measurements may be used to identify a LOS probability for the UE, potentially leading to further inaccuracies when performing various tasks that depend on this information. Implementations of the technology described herein may therefore reduce such inaccuracies, not least by allowing for accurate determination of signal characteristics of the shortest path between the TRP 301 and UE 300.

In some examples, for the plurality of beams associated with the plurality of signal propagation paths, respective contributions to a channel energy may be estimated. As described with reference to FIG. 1, in broad terms, the respective contributions to the channel energy for each beam may, in some examples, be estimated by combining information associated with paths from various different beams in turn. In some examples, a group of paths associated with a shortest path between the UE and the transmit-receive point may be identified from the plurality of signal propagation paths associated with the plurality of beams and based on the estimated contributions to the channel energy, with signal characteristics for the shortest path for use in determining a position of the UE being determined using this identified group of paths. For instance, in some examples, these operations may be performed in the manner described with reference to FIG. 1 above.

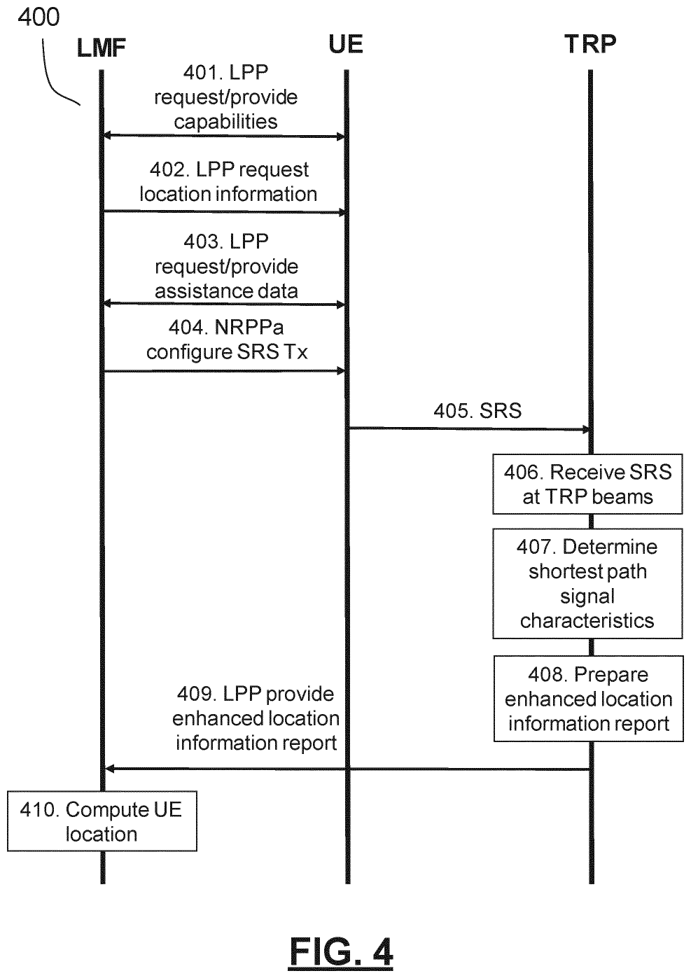

FIG. 4 is a message flow sequence, indicated generally by the reference numeral 400, in accordance with some examples of the described technology. The message flow sequence 200 shows an example implementation of aspects of a process such as that described with reference to FIG. 3 above.

The message flow sequence 400 shows a signalling procedure between a location management function (LMF), a UE and a TRP. In some examples, the LMF may be a core network (CN) entity, but could be elsewhere e.g. at the TRP or UE. The UE and TRP may, for example, be the UE 300 and TRP 301 described with reference to FIG. 3 above. As will be appreciated, various operations and signals depicted in FIG. 4 are similar to those described with reference to FIG. 2. Moreover, whilst various operations are described below as being performed by the LMF, in some examples some or all of these operations may be performed by the UE or TRP instead.

In some examples, LMF and UE may exchange signal(s) 401 relating to positioning protocol capabilities (e.g. LPP capabilities) of the UE device. For instance, in some examples, LMF may send to the UE a signal including data indicative of a request for capabilities (e.g. a ‘RequestCapabilities’ message). Such a message may including one or more requested capability types. In response, the UE may send to the LMF a signal including data indicative its positioning capabilities (e.g. a ‘ProvideCapabilities’ message). Such a message may indicate which, if any, of the requested capability types are supported by the UE. In some examples, the signal including data indicative of the UE's positioning capabilities (e.g. a ‘ProvideCapabilities’ message) may be sent by the UE to the LMF in response to another event without prior reception of the signal including data indicative of a request for capabilities (e.g. the ‘RequestCapabilities’ message). This may be performed for instance, but not limited to, when UE connects to the TRP.

In some examples, LMF may send signal(s) 402 to UE relating to (e.g. LPP) location information. For instance, in some examples, LMF may send to the UE a signal including data indicative of a request for location information (e.g. a ‘RequestLocationInformation’ message). In some examples, the signal including data indicative of a request for location information may indicate a type of the requested location information and/or an associated quality of service (QOS) requirement.

In some examples, LMF and UE may exchange signal(s) 403 relating to positioning protocol (e.g. LPP) assistance data. For instance, in some examples, UE may send to the LMF a signal including data indicative of a request for assistance data (e.g. a ‘RequestAssistanceData’ message). In some such examples, the signal including data indicative of a request for assistance data may include a request for information for use in determining a location of the UE.

In response, the LMF may send to the UE a signal which provides the requested assistance data (e.g. in the form of a ‘ProvideAssistanceData’ message). In some examples, this signal (e.g. the ‘ProvideAssistanceData’ message) may further include unrequested information deemed useful for determining a location of the UE. In some examples, the signal (e.g. the ‘ProvideAssistanceData’ message) may be sent by the LMF to the UE in response to another event without prior reception of a request from the UE (e.g. the ‘RequestAssistanceData’ message). This may occur for instance, but not limited to, when the UE connects to the TRP.

In some examples, LMF may send signal(s) 404 to the UE relating to a sounding reference signal (SRS) transmitter configuration. For instance, these signals may be sent using New Radio Positioning Protocol A (NRPPa). For instance, in some examples, the signals may include information indicative of how the SRS is to be generated, such as, but not limited to, a Zadoff-Chu sequence length/root, a frequency comb, a repetition rate in the time domain, a periodicity in a number of subframes, a carrier frequency to use, and other suitable information.

In some examples, once the SRS transmitter has been configured, the UE may transmit a SRS 405 to the TRP.

In some examples, at operation 406, the TRP may receive the transmitted SRS 405. For instance, the TRP may receive the transmitted SRS 405 via a plurality of beams of the TRP.

In some examples, at operation 407, responsive to receiving the SRS 405, the TRP may determine shortest path signal characteristics based on the received SRS 405. For instance, this operation may be performed in the manner described herein, particularly with reference to FIGS. 1 and 3 above.

In some examples, at operation 408, the TRP may prepare an enhanced location information report. For instance, in some examples, the enhanced location information report may include data indicative of the location information requested in signal(s) 403. In some examples, the shortest path signal characteristics may be included in and/or used to determine the contents of the enhanced location information report.

In some examples, the TRP may send signal(s) 409 relating to location information. For instance, in some examples, TRP may send a signal including data indicative of a ‘ProvideLocationInformation’ message to the LMF. In some examples, the ‘ProvideLocationInformation’ may include the enhanced location report determined at operation 409 and/or the shortest path signal characteristics determined at operation 408.

In some examples, at operation 410, the LMF may compute a location of the UE device. For instance, this location may be determined based on the determined shortest path signal characteristics and/or the enhanced location report included in signal(s) 409.

Whilst various operations have been described above, by way of example only, primarily with respect to LPP and NRPPa, it will be appreciated that other positioning protocols may be used in addition or alternatively.

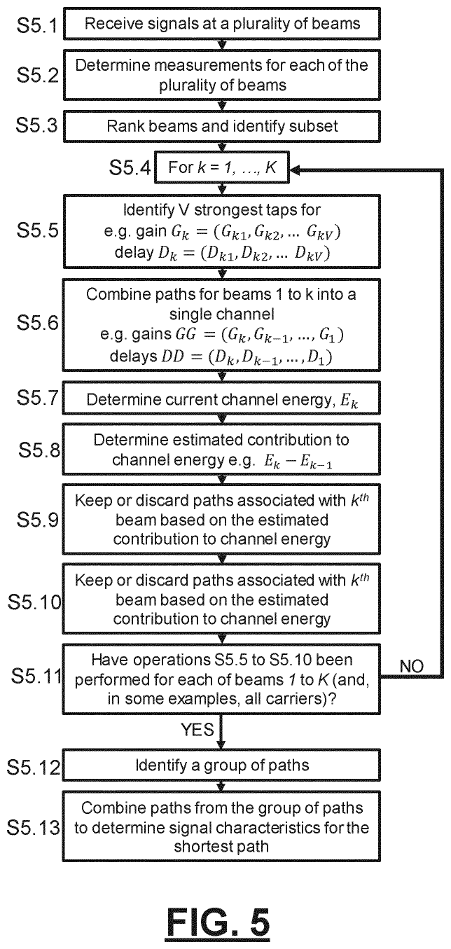

FIG. 5 is a flowchart depicting various operations which may be performed in accordance with example embodiments. For instance, the operations depicted in FIG. 5 may be executed by a UE, TRP or other suitable apparatus. As will of course be appreciated, various operations illustrated in FIG. 5 correspond to operations already described with reference to the preceding Figures, not least with reference to FIG. 1.

In operation S5.1, signals are received at a plurality of beams, the signals having been propagated over a communication channel between a UE and a TRP. In some examples, such as those in which the signals are received at receive beams of a UE, the signals may be downlink positioning reference signals (DL-PRS). In other examples, such as those in which the signals are received at receive beams of a TRP, the signals may be uplink sounding reference signals (UL-SRS).

In operation S5.2, one or more measurements are determined for each beam of the plurality of beams based on the received signals. For instance, in some examples, the one or more measurements may comprise a power measurement (e.g. but not limited to, a reference signal received power, RSRP, measurement, a received signal strength indicator, RSSI,), a signal-to-noise ratio (SNR) measurement, a signal-to-noise-plus-interference ratio (SNIR), a beam line of sight probability, and/or other measurements.

In some examples, respective beam indices may be used to identify measurements corresponding to specific beams of the plurality of beams. In operation S5.3, the beams of the plurality of beams are ranked according to one or more of the determined measurements (e.g. but not limited to, LOS probability) and a subset of the plurality of beams is identified. Such ranking and identification may be performed in any of the ways described in the specification, for instance with reference to the earlier Figures, particularly FIG. 1. In some examples, the beams of the subset are ranked once the subset has been identified. Alternatively, the beams of the plurality of beams may be ranked prior to determining the subset.

In operation S5.4, the operations described with reference to operations S5.5 to S5.9 are iterated over the subset of beams. Put another way, for each value of an iterator k running from 1 to an integer K, where K is the size of the subset (i.e. a desired number of beams for combining), the operations described with reference to operations S5.5 to S5.9 may be performed for the k^{th} beam. As described above with reference to FIG. 1, 20) in some examples, this iteration may be performed across multiple carriers having respective pluralities of beams. In examples in which the iteration is performed across multiple carriers, operation S5.1 may include collecting signals at each receive beam and at each carrier. In such examples, operations S5.5 to S5.9 may be repeated for the multiple carriers, resulting in a combined channel having paths associated with beams from one or more of the multiple carriers. In some examples, either or both of the desired number of beams for combining from each carrier and a threshold estimated respective contribution to the channel energy used to identify the combined channel may depend on the carrier of the iteration (i.e. the carrier being considered in a given iteration).

In operation S5.5, the signals received at the k^{th} beam of the subset of the plurality of beams may be parsed to identify one or more taps. For instance, the taps may correspond to different propagation paths taken by the received signals during propagation over the communication channel between the UE and TRP. As described above with reference to operation S5.4, this operation is performed for each of the beams of the subset. In some such examples, parsing the signals may allow for the V strongest taps for each beam to be identified, where Vis a positive integer corresponding, in some examples, to a maximum number of channel paths.

As described with reference to FIG. 1, in some examples, the identified taps/paths may be associated with various signal characteristics. For instance, a given path may be associated with a respective path gain and path delay. In some examples, the respective path delays of the V paths associated with the k^{th} beam may be represented by the vector Dₖ=(Dₖ₁, D_{K2}, . . . . D_{kV}). Similarly, the respective path gains of the V paths associated with the k^{th} beam may be represented by the vector Gₖ=(Gₖ₁, Gₖ₂, . . . . Gₖᵥ).

In operation S5.6, paths corresponding to the beams 1 to k may be combined into a single channel. For instance, as described above, in some examples vectors GG and DD, may be determined by appending GG=(Gₖ, Gₖ₋₁, . . . , G₁) and DD=(Dₖ, Dₖ₋₁, . . . , D₁).

In operation S5.7, a current channel energy, Eₖ, for the channel resulting from combining the paths associated with beams 1 to k is determined. This may be performed in the manner described with reference to FIG. 1. For instance, in some examples Eₖ may be obtained by averaging a total channel frequency response (CFR) for the channel resulting from combining the paths associated with beams 1 to k across one across one or more subcarriers associated with the channel (e.g. but not limited to all subcarriers of the channel). It will be appreciated that alternative methods for calculating Eₓ may be used in addition or alternatively.

In operation S5.8, the channel energy Eₖ is compared with channel energy Eₖ₋₁ so as to determine an estimated respective contribution for the k^{th} beam to the channel energy. For instance, in some examples, the estimated respective contribution may be a difference between Eₖ and Eₖ₋₁.

In operation S5.9, if the estimated respective contribution to the channel energy for the k^{th} beam is determined to be low or insignificant (e.g. below a threshold), the paths associated with the k^{th} beam may be discarded (i.e. Gₓ and D_{K} are removed from GG and DD for subsequent iterations). Otherwise, the k^{th} beam is kept in the combined channel.

In operation S5.10, the method proceeds to operation S5.11 if each of beams 1 to K (and, in some examples, also carriers) have been iterated over as described above. Otherwise, the method returns to operation S5.4 and the next beam/carrier is processed.

In operation S5.11, a combined channel is returned. For instance, this combined channel may take the form of vectors GG and DD described above, with paths associated with ‘low energy’ beams discarded.

In operation S5.12, a group of paths is identified. For instance, as described with reference to FIG. 1, this group of paths may correspond to an earliest group of paths from the combined channel (i.e. group of least path delay) having a group energy, E_{G}, larger than a noise threshold.

In operation S5.13, paths from the group of paths are combined in order to determine signal characteristics for the shortest path for use in determining a position of the UE. For instance, the signal characteristics for the shortest path may be determined based on signal characteristics of the paths of the identified group of paths.

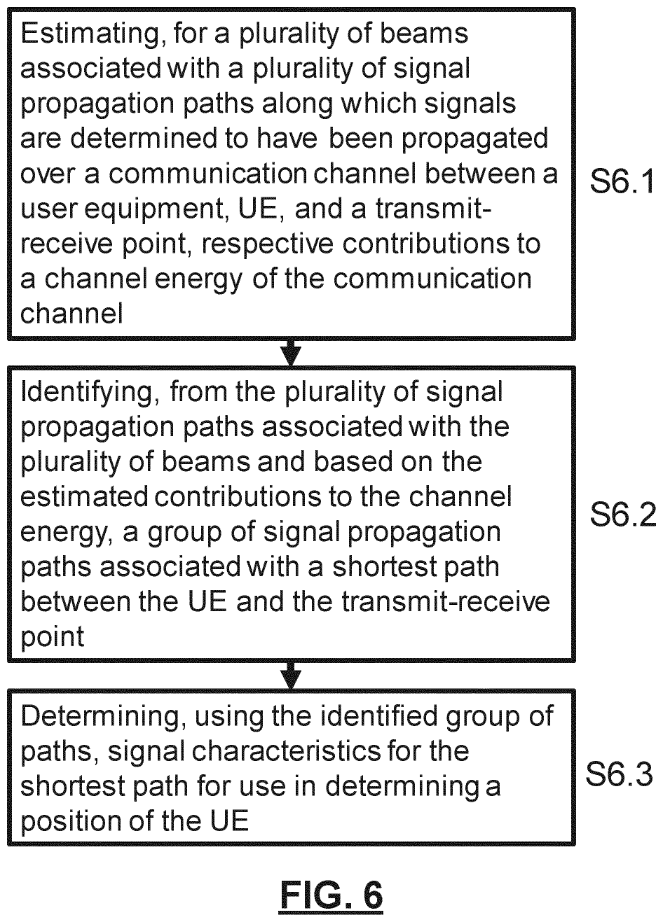

FIG. 6 is a flowchart depicting various operations which may be performed in accordance with various examples. As will of course be appreciated, in some examples, different operations may be performed by different entities (e.g. but not limited to a UE device, a TRP, or other suitable computing apparatus). In other examples, one or more of the operations may be performed by different entities.

In operation S6.1, for a plurality of beams associated with a plurality of signal propagation paths along which signals are determined to have been propagated over a communication channel between a user equipment, UE, and a transmit-receive point, respective contributions to a channel energy of the communication channel are estimated.

In operation S6.2, a group of paths associated with a shortest path between the UE and the transmit-receive point is identified from the plurality of signal propagation paths associated with the plurality of beams and based on the estimated contributions to the channel energy.

In operation S6.3, signal characteristics for the shortest path for use in determining a position of the UE are determined using the identified group of paths.

As will of course be appreciated, various operations illustrated in FIG. 6 may correspond to operations already described with reference to the preceding Figures. For instance, operation S6.1 may correspond to one or a combination of operations S5.1 to S5.11 of FIG. 5. Likewise, operation S6.2 may correspond to operation S5.12 of FIG. 5. Operation S6.3 may correspond to operation S5.13 of FIG. 5.

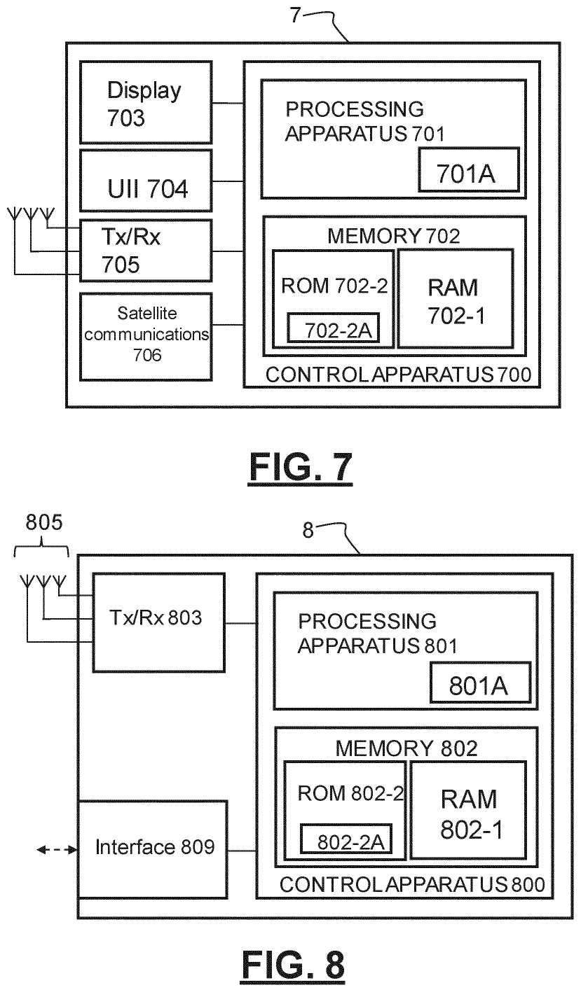

FIG. 7 is a schematic illustration of an example configuration of a computing apparatus 7 which may be configured to perform various operations described with reference to FIGS. 1 to 6.

Computing apparatus may comprise control apparatus 700 which is configured to control operation of other components which form part of the computing apparatus 7 thereby to enable performance of various operations described with reference to FIGS. 1 to 6. The computing apparatus 700 may comprise processing apparatus 701 and memory 702. Computer-readable code 702-2A may be stored on the memory 702, which when executed by the processing apparatus 701, causes the control apparatus 700 to perform any of the operations described herein (e.g. but not limited to those operations attributed to UEs)

In addition, computing apparatus may further include a display 703, user interactive interface (UII) 704, radio frequency interface 705 and global navigation satellite system (GNSS) 706. In some examples, other satellite communications systems may be used instead of or in addition to GNSS 706.

FIG. 8 is a schematic illustration of an example configuration of transmit-receive point 8 which may be configured to perform various operations described with reference to FIGS. 1 to 6.

The transmit-receive point 8, which may be referred to as an access point (AP), a base station or an eNB, comprises control apparatus 800 which is configured to control operation of other components which form part of the transmit-receive point 8 thereby to enable transmission of signals to and receipt of signals from UEs in its coverage area vicinity. For example, the transmit-receive point control apparatus 800 is configured to cause transmission of reference signals to UEs within its coverage area. Furthermore, in some examples, the control apparatus 800 may be configured to enable receipt of reference signal measurement data and/or location data from the UEs in its coverage area. The control apparatus 800 may also enable communication with other transmit-receive point and/or other network nodes. The control apparatus 800 may additionally be configured to cause performance of any other operations described herein with reference to the transmit-receive point 8.

The transmit-receive point 8 comprises a radio frequency antenna array 805 configured to receive and transmit radio frequency signals. Although the transmit-receive point 8 in FIG. 8 is shown as having an array 805 of three antennas, this is illustrative only. The number of antennas may vary, for instance, from one to many hundreds.

The transmit-receive point 8 further comprises a radio frequency interface 803 configured to interface the radio frequency signals received and transmitted by the antenna 805 and a control apparatus 80. The radio frequency interface 803 may also be known as a transmitter, receiver and/or transceiver. The transmit-receive point 8 may also comprise an interface 808 via which, for example, it can communicate with other network elements such as other transmit-receive points and/or other network entities.

The transmit-receive point control apparatus 800 may be configured to process signals from the radio frequency interface 803, to control the radio frequency interface 803 to generate suitable RF signals to communicate information to UEs via the wireless communications link, and also to exchange information with other transmit-receive point 8 and network entities via the interface 808.

The control apparatus 800 may comprise processing apparatus 801 and memory 802. Computer-readable code 802-2A may be stored on the memory 802, which when executed by the processing apparatus 801, causes the control apparatus 800 to perform any of the operations described herein and attributed to the transmit-receive point 8.

Some further details of components and features of the above-described devices/entities/apparatuses 7, 8 and alternatives for them will now be described.

The control apparatuses described above 700, 800 may comprise processing apparatus 701, 801 communicatively coupled with memory 702, 802. The memory 702, 802 has computer readable instructions 702-2A, 802-2A stored thereon, which when executed by the processing apparatus 701, 801 causes the control apparatus 700, 800 to cause performance of various ones of the operations described with reference to FIGS. 1 to 6. The control apparatus 700, 800 may in some instance be referred to, in general terms, as “apparatus”.

The processing apparatus 701, 801 may be of any suitable composition and may include one or more processors 701A, 801A of any suitable type or suitable combination of types. Indeed, the term “processing apparatus” should be understood to encompass computers having differing architectures such as single/multi-processor architectures and sequencers/parallel architectures. For example, the processing apparatus 701, 801 may be a programmable processor that interprets computer program instructions 702-2A, 802-2A and processes data. The processing apparatus 701, 801 may include plural programmable processors. Alternatively, the processing apparatus 701, 801 may be, for example, programmable hardware with embedded firmware. The processing apparatus 701, 801 may alternatively or additionally include one or more specialised circuit such as field programmable gate arrays FPGA, Application Specific Integrated Circuits (ASICs), signal processing devices etc. In some instances, processing apparatus 701, 801 may be referred to as computing apparatus or processing means.

The processing apparatus 701, 801 is coupled to the memory 702, 802 and is operable to read/write data to/from the memory 702, 802. The memory 702, 802 may comprise a single memory unit or a plurality of memory units, upon which the computer readable instructions (or code) 702-2A, 802-2A is stored. For example, the memory 702, 802 may comprise both volatile memory 702-1, 802-1 and non-volatile memory 702-2, 802-2. In such examples, the computer readable instructions/program code 702-2A, 802-2A may be stored in the non-volatile memory 702-2, 802-2 and may be executed by the processing apparatus 701, 801 using the volatile memory 702-1, 802-1 for temporary storage of data or data and instructions. Examples of volatile memory include random-access memory (RAM), dynamic random-access memory (DRAM), and synchronous dynamic random-access memory (SDRAM) etc. Examples of non-volatile memory include read-only memory (ROM), programmable read-only memory (PROM), electronically erasable programmable read-only memory (EEPROM), flash memory, optical storage, magnetic storage, etc.

The memory 702, 802 may be referred to as one or more non-transitory computer readable memory medium or one or more storage devices. Further, the term ‘memory’, in addition to covering memory comprising both one or more non-volatile memory and one or more volatile memory, may also cover one or more volatile memories only, one or more non-volatile memories only. In the context of this document, a “memory” or “computer-readable medium” may be any media or means that can contain, store, communicate, propagate or transport the instructions for use by or in connection with an instruction execution system, apparatus, or device, such as a computer.

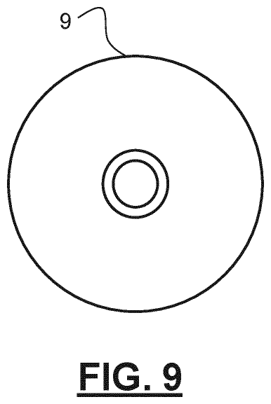

The computer readable instructions/program code 702-2A, 802-2A may be pre-programmed into the control apparatus 700, 800. Alternatively, the computer readable instructions 702-2A, 802-2A may arrive at the control apparatus via an electromagnetic carrier signal or may be copied from a physical entity 9 such as a computer program product, a memory device or a record medium such as a compact disc read-only memory (CD-ROM) or digital versatile disc (DVD) an example of which is illustrated in FIG. 9. The computer readable instructions 702-2A, 802-2A may provide the logic and routines that enables the entities devices/apparatuses 7, 8 to perform the functionality described above. The combination of computer-readable instructions stored on memory (of any of the types described above) may be referred to as a computer program product. In general, references to computer program, instructions, code etc. should be understood to express software for a programmable processor firmware such as the programmable content of a hardware device as instructions for a processor or configured or configuration settings for a fixed function device, gate array, programmable logic device, etc.

If desired, the different functions discussed herein may be performed in a different order and/or concurrently with each other. Furthermore, if desired, one or more of the above-described functions may be optional or may be combined. Similarly, it will also be appreciated that the flow diagrams of FIGS. 5 and 6 are examples only and that various operations depicted therein may be omitted, reordered and/or combined.

Although the methods and apparatuses have been described in connection with an E-UTRA network, it will be appreciated that they are not limited to such networks and are applicable to radio networks of various different types.

Although various aspects of the methods and apparatuses described herein are set out in the independent claims, other aspects may comprise other combinations of features from the described embodiments and/or the dependent claims with the features of the independent claims, and not solely the combinations explicitly set out in the claims.

It is also noted herein that while various examples are described above, these descriptions should not be viewed in a limiting sense. Rather, there are several variations and modifications which may be made without departing from the scope of the present invention as defined in the appended claims.

1. An apparatus comprising at least one processor and at least one memory including computer program code, the at least one memory and the computer program code being configured to, with the at least one processor, cause the apparatus at least to perform:
estimating, for a plurality of beams associated with a plurality of signal propagation paths along which signals are determined to have been propagated over a communication channel between a user equipment, UE, and a transmit-receive point, respective contributions to a channel energy of the communication channel;
identifying, from the plurality of signal propagation paths associated with the plurality of beams and based on the estimated contributions to the channel energy for the plurality of beams, a group of signal propagation paths associated with a shortest path between the UE and the transmit-receive point; and
determining, using the identified group of paths, signal characteristics for the shortest path for use in determining a position of the UE; and
determining a likelihood that the shortest path between the UE and the transmit-receive point is a line of sight path, wherein the likelihood is determined based on a LOS probability, wherein the LOS probability is determined using the signal characteristics of the shortest path.

2. (canceled)

3. The apparatus of claim 1, wherein the beams are beams of the transmit-receive point.

4. The apparatus of claim 1, wherein the beams are beams of the UE.

5. The apparatus of claim 1,
wherein measurements of signals propagated via at the plurality of beams are used to determine a subset of the plurality of beams, and
wherein the group of paths is identified from paths of the plurality of signal propagation paths that are associated with the subset of the plurality of beams and based on the estimated contributions to the channel energy for the beams of the subset.

6. The apparatus of claim 5, wherein the subset is determined based on a desired number of beams for combining, and wherein a value for the desired number of beams for combining is defined by information received from a location management function or based on a width associated with the plurality of beams.

7. The apparatus of claim 5, wherein the subset is determined by removing beams from the plurality of beams having a respective determined measurement below a threshold.

8. The apparatus of claim 1, wherein the plurality of signal propagation paths associated with the plurality of beams are identified by parsing signals propagated via at the plurality of beams.

9. The apparatus of claim 1, wherein the respective contribution to the channel energy for a given beam is determined by:
determining a first energy that is associated with a first combined channel formed by combining paths from the plurality of signal propagation paths that are associated with multiple beams of the subset, the given beam being included in the multiple beams; and
determining a second energy that is associated with a second combined channel formed by combining paths from the plurality of signal propagation paths that are associated with multiple beams of the subset, but excluding the paths associated with the given beam,
wherein the respective contribution to the channel energy for a given beam is determined based on a difference between the determined first energy and the determined second energy.

10. The apparatus of claim 9, wherein the first energy is determined by averaging, across one or more subcarriers of the first combined channel, a first channel frequency response associated with the first combined channel; and/or
wherein the second energy is determined by averaging, across one or more subcarriers of the second combined channel, a second channel frequency response associated with the second combined channel.

11. The apparatus of claim 1, wherein the group of paths is identified from a combined channel comprising paths of the plurality of signal propagation paths that are associated with beams having at least a threshold estimated respective contribution to the channel energy.

12. The apparatus of claim 11, wherein the group of paths is identified as an earliest group of paths from the combined channel having a group energy larger than a noise threshold.

13. The apparatus of claim 11, wherein the group of paths is identified from the combined channel using a sliding window.

14. The apparatus of claim 1, wherein the signal characteristics for the shortest path are determined based on signal characteristics of the paths of the group of paths.

15. The apparatus of claim 14, wherein the signal characteristics for the shortest path include a shortest path delay, and wherein the shortest path delay is determined based on respective path delays of paths from the group of paths.

16. The apparatus of claim 14, wherein the signal characteristics for the shortest path include a shortest path gain, and wherein the shortest path gain is determined based on respective path gains of paths from the group of paths.

17. A user equipment device comprising the apparatus of claim 1.

18. A transmit-receive point for a communications network comprising the apparatus of claim 1.

19. A method comprising:
estimating, for a plurality of beams associated with a plurality of signal propagation paths along which signals are determined to have been propagated over a communication channel between a user equipment, UE, and a transmit-receive point, respective contributions to a channel energy of the communication channel;
identifying, from the plurality of signal propagation paths associated with the plurality of beams and based on the estimated contributions to the channel energy for the plurality of beams, a group of signal propagation paths associated with a shortest path between the UE and the transmit-receive point;
determining, using the identified group of paths, signal characteristics for the shortest path for use in determining a position of the UE; and
determining a likelihood that the shortest path between the UE and the transmit-receive point is a line of sight path, wherein the likelihood is determined based on a LOS probability, wherein the LOS probability is determined using the signal characteristics of the shortest path.

20. A non-transitory computer readable medium comprising program instructions stored thereon for performing at least the method of claim 19.

21. (canceled)
